(19) United States
(12) Patent Application Publication
(10) Pub. No.: US 2010/0241573 A1
(43) Pub. Date: Sep. 23, 2010

(54) Conducting Customized Market Surveys with Transactional Data

(75) Inventors: David Joa, Irvine, CA (US); Debashis Ghosh, Charlotte, NC (US); David N. Joffe, Charlotte, NC (US); Kurt Newman, Matthews, NC (US); Thayer S. Allison, JR., Charlotte, NC (US); Aaron Lai, Alameda, CA (US); Mark V. Krein, Charlotte, NC (US); Sudeshna Banerjee, Waxhaw, NC (US); Yanghong Shao, Charlotte, NC (US); Timothy John Bendel, Charlotte, NC (US); Samuel Jeff Carter, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/405,748

(22) Filed: Mar. 17, 2009

(51) Int. Cl. G06Q 10/00; G06F 17/30; G06F 17/40; G06Q 30/00; G06Q 40/00; G06Q 20/00

(52) U.S. Cl. 705/80; 705/10; 705/39; 707/E17.014; 707/E17.044

(57) ABSTRACT

Systems and methods for consumer participation in a marketing survey and for development of marketing solicitations by corporate clients based on consumer transactional/demographic data are described. An individual seeking to participate in a marketing survey may first choose to be included in a database containing many surveys that have been added by corporate sponsors. The system may select a willing consumer for participation in the survey based on predefined preferred data metrics. Upon participation, the consumer may also receive a reward in the form of a cash payment or gift, which the system may credit directly to the consumer's bank account and/or to the consumer's account with a corporate affiliate. In addition, the platform may be used to generate marketing contact lists based on consumer demographic and transactional data for a corporate client.

### BACKGROUND

Market research and direct marketing and surveying are important tools for effectively bringing new products to consumers. Traditionally, market research has focused on cold-calling a list of previously registered focus group participants to prequalify prospects for sponsored research studies. Qualified participants are compensated with a stipend typically ranging from $50 to $500, depending on the requirements of the target consumer segment. For example, professional executives may be compensated at a higher rate compared to a focus group participant who works as a retail clerk.

Online research companies have performed services similar to offline research companies with the notable difference that the survey and focus group studies may be conducted online. Much as their offline counterparts maintain a list of prospects, online research companies may use the internet to recruit and qualify focus group participants and survey takers. Just as offline research companies offer a stipend or other forms of compensation to participants, online research companies may offer compensation to participants in the form of cash and/or a points reward system. In a points reward system, participants may receive points for each completed survey and online focus group. After accumulating enough points, participants may exchange points for products, cash, and airline miles, among others.

Partnerships and ventures between manufacturers, airlines, and research companies are a more recent evolution of companies engaged in market research. In such a partnership, a company with a base of consumers may make its consumer base accessible to market research companies. The research companies may offer a bounty or reward to each company that provides its consumer lists. Consumers, in return, may receive remuneration in the form of cash, airline miles, points to be exchanged for products, etc.

Finally, targeted marketing efforts may rely on a list of consumers who also fit pre-defined criteria. List brokers source prospects in various ways, sometimes without the consent and/or knowledge of individuals. For example, a person entering a sweepstakes at a shopping mall could eventually have his or her contact information in a list aggregator's database. The list aggregator would in turn sell this information to companies, small businesses, non-profit organizations, and individuals for a fee. All the while, the individual who had completed the entry form does not benefit from the future sale of the information.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present disclosure are directed to conducting customized transactional data-based market research and consumer list preparation with depersonalized consumer data including reward and compensation algorithms to elicit voluntary participation in the market research studies and receipt of marketing communications. The market research and consumer list preparation may be based on preexisting databases and the information stored therein already maintained by a large financial institution, e.g., Bank of America Corporation.

Aspects of the invention provide a secured platform to allow industry users of data, such as market research companies, surveying companies, large corporations with internal customer research departments, academia, and news service providers, to rapidly select a population to engage in market research to test new products, concepts, marketing campaigns, product enhancements, political polls, etc. In addition, encryption layers provided in the platform may enable the secured import and export of data from the platform. The secured platform may also enable the exchange of information between the platform and a syndicate or corporate affiliate including data providers other than the original financial institution maintaining the database or the original survey sponsor (e.g., mobile wireless carriers, grocery chain, retailers, etc.) The involvement of these affiliates may allow earned rewards to be directly credited to a consumer's account with the affiliate (free mobile minutes with a wireless carrier, food coupons for a grocery chain, etc). In addition, the affiliate may provide more transactional and/or demographic consumer data to the platform. The market survey population may include customers of the financial institution, as well as prospects of the financial institution who have voluntarily agreed to be solicited for market research purposes and marketing communications. In exchange for participating in these market research studies, participants may be compensated either with products or money that may be credited directly to a bank account or coupons for product discounts and complimentary samples.

For market research companies and users of this data platform, the financial institution (or other provider) may offer services including design of experiment, analytics, and reports. Furthermore, to ensure the brand integrity of the financial institution and participant companies/entities, an added layer of brand and marketing advocacy may be used to ensure research proposals and market studies presented to customers of the financial institution are consistent with brand, customer advocacy, marketing, and privacy guidelines set forth by the financial institution.

Another aspect of the invention may provide marketing contact list generation services. The system may automatically generate marketing contact lists based on demographic criteria specified by the list requester. The marketing contact lists may be limited to only those consumers or clients who had already granted permission to receive market surveys and/or other marketing materials including phone solicitations, emails, in-person promotions, etc. Customers who are selected for marketing promotions or included in marketing lists may receive compensation and/or accrue points in a rewards system based upon their inclusion in the list and/or the subsequently marketing promotion/survey. Users may be required to doubly opt-in, e.g., opt-in once for the market survey module, and opt-in a second time to be included in marketing lists generated by the system.

In one embodiment of the present disclosure, a data processing system may analyze information from raw transactional data associated with a consumer of a financial entity such as a bank to determine the relevancy of a particular consumer to the needs of a survey sponsor. To achieve this understanding, a data processing system may access a database of consumer data and analyze the data using a variety of algorithms in view of the sponsor's survey goals. Once analyzed, the data processing system may determine whether or not the consumer may be a good match for survey participation, e.g., based on demographic information. In addition, consumers may also have control over the process by bidding on a desired reward in return for participation, or offered some form of compensation in return for participation in one or more surveys.

An encryption module of the data processing system may ensure that all information—whether user input or reports, raw data, etc.—can only be viewed and accessed securely via the platform. The encryption overlay may encrypt data at multiple points of data exchange. For instance, data may be encrypted at points in the system when: (1) data is exchanged between a financial institution (or corporate affiliate) and the market survey platform, (2) data is exchanged between the market survey platform and the survey sponsors such as commercial users of the platform, and (3) data is exchanged between the survey consumers and the platform (e.g., when a survey responder answers a survey).

The data processing system may also incorporate a rewards fulfillment module. This module may be interconnected to the consumers' checking, savings, or other forms of bank accounts that would enable the seamless transfer of earned rewards (cash or miles, etc.) from the platform to the consumers' accounts. For instance, in the case of the awarding of airline miles, certain airline carriers (e.g., Delta, United Airlines, etc) may participate in the survey system such that if the survey-taking consumer also has an account with the participating airline carrier, the survey-taking consumers could transfer earned airline miles directly to the account with the airline carrier. In this way, a corporate affiliate may interact with the data processing system to facilitate the disbursement of earned rewards.

In another embodiment, a data processing system performs a method for performing market surveys. The data processing system receives transaction data and demographic data for a plurality of consumers, and stores the transaction data and demographic data for the plurality of consumers in a consumer database. Each transaction data entry corresponds to a purchase by one of the consumers and the demographic data comprises non-personally identifiable information. The data processing system prevents exposure to personally identifiable information by a market researcher, and stores market survey data received from the market researcher in a market survey database. The data processing system selects a plurality of consumers based on each consumer's corresponding demographic data as compared to one or more predefined preferred demographic data metrics identified by the market researcher. After completing the surveys, the data processing system receives market survey responses from a plurality of consumers, and stores the market survey responses from the plurality of consumers selected to participate in the market survey in the market survey database.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is a flowchart of an illustrative method for storing consumer information in a system database in accordance with at least one aspect of the present disclosure;

FIGS. 4a, 4b, and 4c are a collection of illustrative screen shots displaying consumer transactional data metrics generated by a survey participation module in accordance with at least one aspect of the present disclosure;

FIGS. 5a and 5b are illustrative screen shots of example transactional and demographic consumer data metrics analyzed by a survey participation module for a particular marketing survey in accordance with at least one aspect of the present disclosure;

FIG. 6 is a flowchart of an illustrative method for conducting a customized marketing survey with consumer rewards in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

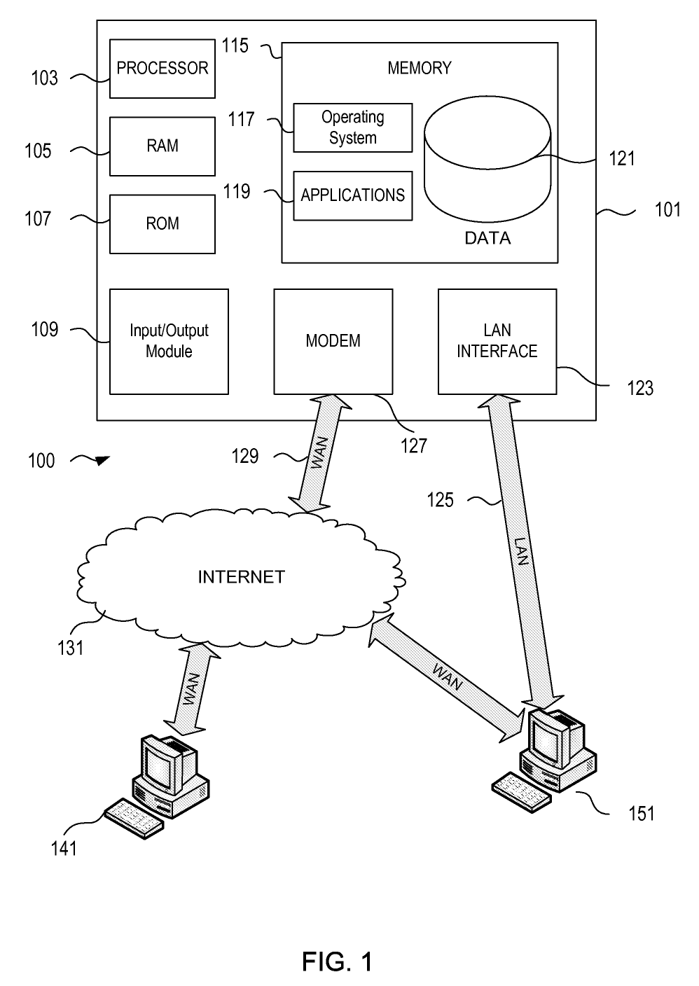

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including RAM 105, ROM 107, input/output module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the server 101 according to an illustrative embodiment of the disclosure may include computer executable instructions for invoking functionality related to conducting market research and customer list preparation with depersonalized customer data including reward and compensation algorithms, as further described herein.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

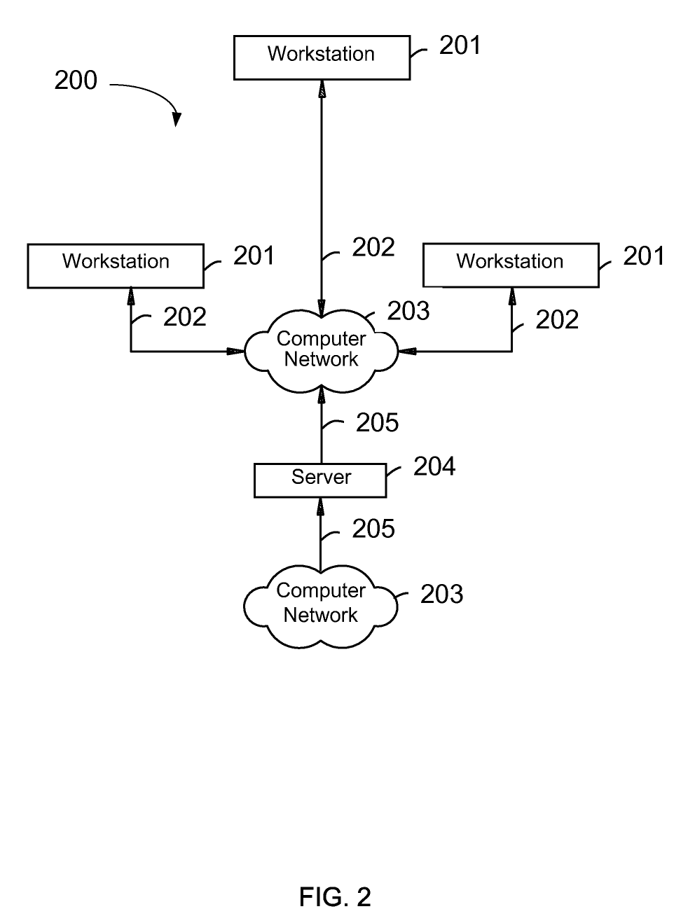

FIG. 2 shows an illustrative system 200 for implementing methods according to the present disclosure. As illustrated, system 200 may include one or more workstations 201. Workstations 201 may be local or remote, and are connected by one or more communications links 202 to computer network 203 that is linked via communications links 205 to server 204. External users, e.g., market survey researchers and consumers, may use workstations 101 to access the system server 104.

In system 200, server 204 may be any suitable server, processor, computer, or data processing device, or combination of the same. The server 204 may include a consumer database storing encrypted transactional data and demographic data for many consumers, e.g., database 121. The transactional data may be obtained from other databases associated with a financial institution, and preferably stores financial transaction data in such a manner that the financial transaction data can be reviewed by market researchers without revealing personally identifiable information about the individual(s) with which each transaction is associated. For example, personally identifiable information may be encrypted with access only provided to the corresponding customer(s) and appropriate personnel at the financial institution. Alternatively, the personally identifiable information may be stored in a separate secure location or database, and correlated to each transaction using a user ID, key, or the like, so that when or if a market researcher reviews the data the market researcher cannot review personally identifiable information. Market researchers may still have access to non-personally identifying information, e.g., zip code, gender, age, household income, store of purchase, item purchased, etc.

Server 204 may also include a market survey database storing market survey data received from market researchers and market survey responses received from consumers selected to participate in the market survey. A market survey researcher may upload or otherwise present market survey data to the database, and may also specify ideal candidates for response to the market survey. In this manner a market researcher can specify the scope of consumers who are eligible for responding to the survey, e.g., 18-34 year olds of either gender. The market researcher may further specify a preferred candidate, e.g., 18-24 year old men. The market researcher may specify any number of one or more preference levels, and each preference level may be associated with a different reward or bid limit, as further explained below.

Server 204 may also include a participation module for receiving bids from consumers to participate in the market survey and for determining whether to accept each consumer for participation in the survey based on predefined rules identifying maximum acceptable bids in view of consumer demographics. In one illustrative embodiment, a consumer is rewarded for participation in a survey, provided the consumer meets the broadest allowable scope for inclusion in the survey. For example, where the broadest scope is “18-34 year olds of either gender” anyone between 18 and 34 years old, inclusive, may participate in the survey. Each preference level is associated with a reward or benefit that is provided to the user in return for completing the survey.

The benefits might be defined in one or more levels, corresponding to the one or more preference levels identifying consumers for inclusion in the survey. Table 1 below illustrates a sample set of preference levels with the bid/benefit associated with each level.

TABLE 1

| Preference | | |
|---|---|---|
| Level | Description | Benefit |
| 1 | 18-21 year olds | $10 |
| 2 | 21-25 year old women | $8 |
| 3 | 21-25 year old men | $6 |
| 4 | 26-34 year old women | $4 |
| 5 | 26-34 year old men | $2 |
| 6 | 35-36 year olds | $0, but allowed to |
| | | participate. |

Table 1 illustrates six preference levels. However, more or fewer may be used. In addition, preference levels might not be based on age and/or gender, but rather might be based on any non-personally identifying demographic criterion, e.g., geographic location, household income, ownership of a game console, or any consumer associated with a transaction meeting specific conditions. For example, a survey about video game preferences might be limited to consumers associated with a transaction in which a game console or video game was purchased. The preference levels may further be refined based on which game console (XBOX360, PlayStation 3, or Wii) or which game in particular was purchased. Any number of preference levels may be used, and any non-personally identifying criterion or criteria may be used.

In another illustrative embodiment, consumers may bid for inclusion in a survey. Each user's bid reflects the amount of money, credits, goods, or other benefits the user wants in return for completing the survey. If the user's bid falls within the limits specified by the market researcher, the administrator, survey sponsor, or other appropriate entity, then the user is allowed to complete the survey and, upon completion, is given the corresponding benefit. For example, a consumer may offer to participate in a survey in return for $5. If $5 is less than or equal to the benefit for that consumer's preference level (see, e.g., Table 1), then the consumer is invited or allowed to participate in the survey. Upon completion of the survey, the user is provided his or her bid, regardless of what the actual maximum or defined benefit might otherwise be. To allow consumers and survey sponsors to analyze trends in compensation levels, the rewards module may process and display population statistics. This module may display information such as typical survey compensation for the type of survey offered, number of survey participants that have earned over a certain amount of points/dollars, number of survey responders available to survey providers at a certain bid level, etc.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

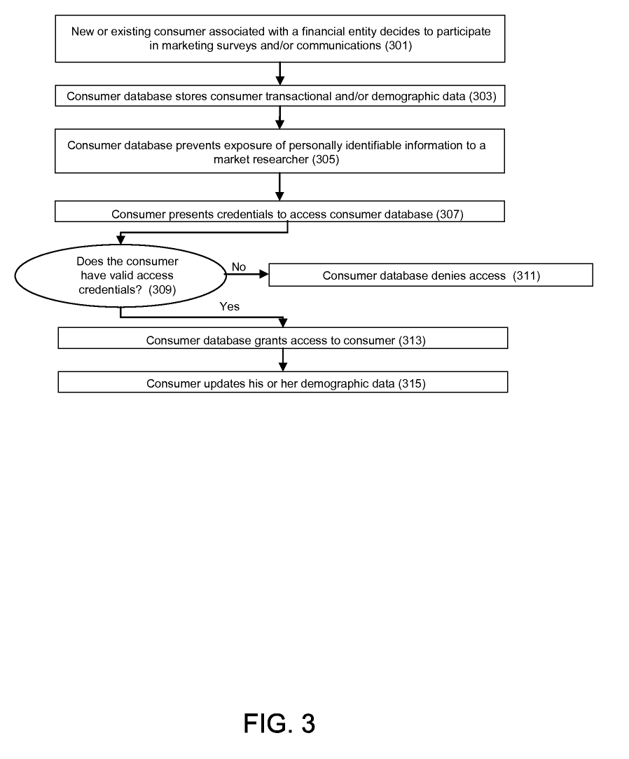

FIG. 3 is a flowchart of an illustrative method for storing and updating consumer transactional and demographic data in accordance with at least one aspect of the present disclosure. In step 301, a new or existing consumer associated with a financial entity, such as a bank, credit card company, brokerage, and others, may decide to enroll in a marketing survey service. Existing consumers may already have their transactional and/or demographic data stored at the financial entity. Transactional data may include any number of financial statements including credit card bill statements and bank account balances. Demographic data may include consumer profile information such as the name, address, age, sex, race, number of members in household, income, education level, political party affiliation, and other information that may go along with these statements. Then in step 303, a consumer database may store a consumer's transactional and/or demographic data. Corporate affiliates of the financial entity may also add more consumer transactional and demographic data. Corporate affiliates may cull the appropriate consumer data from accounts that the consumer has with them. For instance, if a mobile wireless carrier was a corporate affiliate, the number of cell phone usage minutes may be available as consumer data available for the platform to use. Corporate affiliates may use the same or a separate interface as consumers in adding consumer data. Then in step 305, the consumer database may prevent exposure of personally identifiable information to a market researcher. This security feature may be implemented through a variety of hardware and/or software features associated with server 204. From a hardware perspective, personally identifiable data may be stored in a different location from other consumer and transactional data. From a software perspective, a number of security, encryption, and/or access restrictions such as those implemented via a password/ID may be present.

The platform may provide encryption capabilities at multiple gateways within the platform when information is being exchanged. This encryption module may be present as a separate hardware entity within server 204 or may be present as part of the consumer database, participation module, or market survey database. Encryption may occur when data is being provided to the platform or when the platform is providing data to an external entity. For instance, when the survey sponsor and the platform exchange consumer data information, the data may be encrypted before transfer. Similarly, the platform may allow for encryption before the exchange of data with corporate affiliates and/or with the financial institution.

Next, in step 307, a consumer may present access credentials to be authenticated to login to the consumer database. Proper access credentials may include any number of unique codes, including a username and password, voice recognition, or fingerprint analysis, among others. The process then may move to decision step 309 where the consumer database may decide whether the consumer possesses adequate access credentials. If the consumer does not have the proper credentials, then the consumer database denies access in step 311. If the consumer does possess adequate credentials, then the consumer database may grant access in step 313. Then in step 315, the consumer may access her profile and update any demographic data such as name, age, sex, etc. that may be incorrectly displayed on her profile. In this way, the database may be kept current and the consumer may have some control over her profile information.

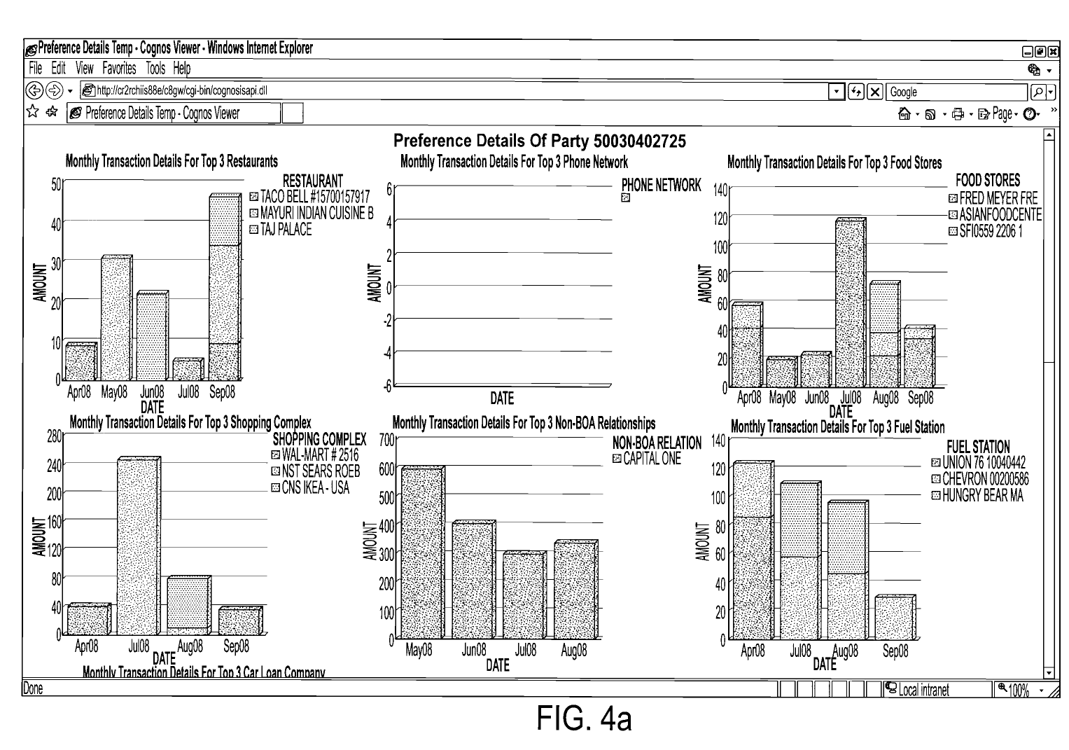

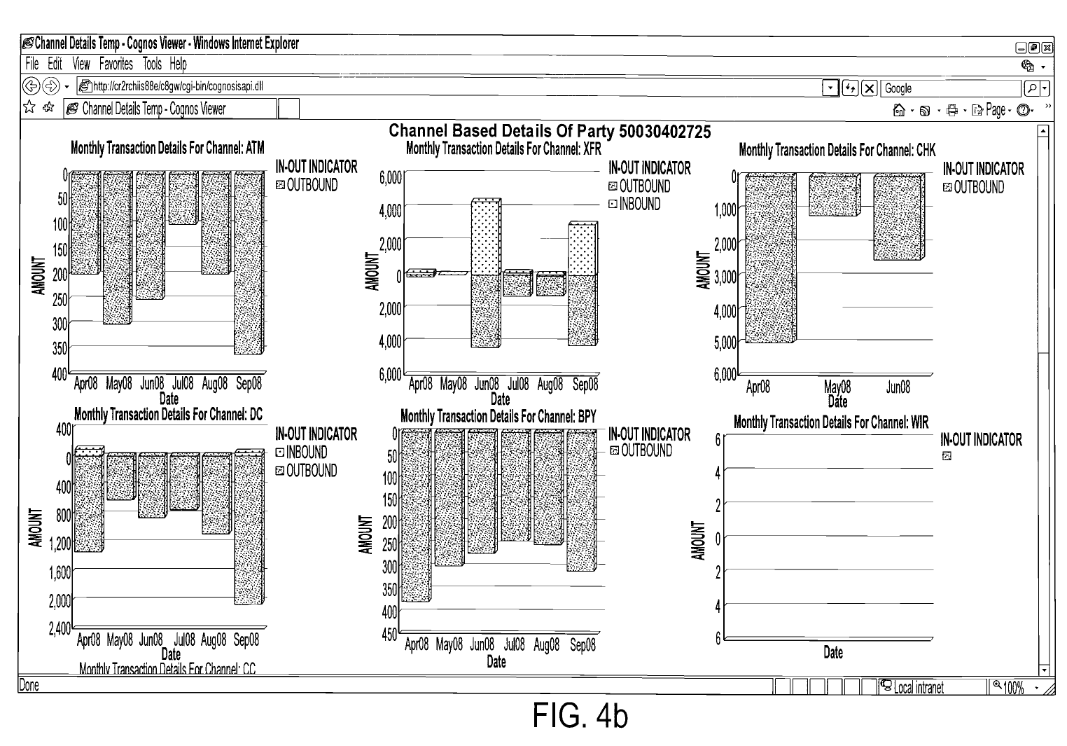

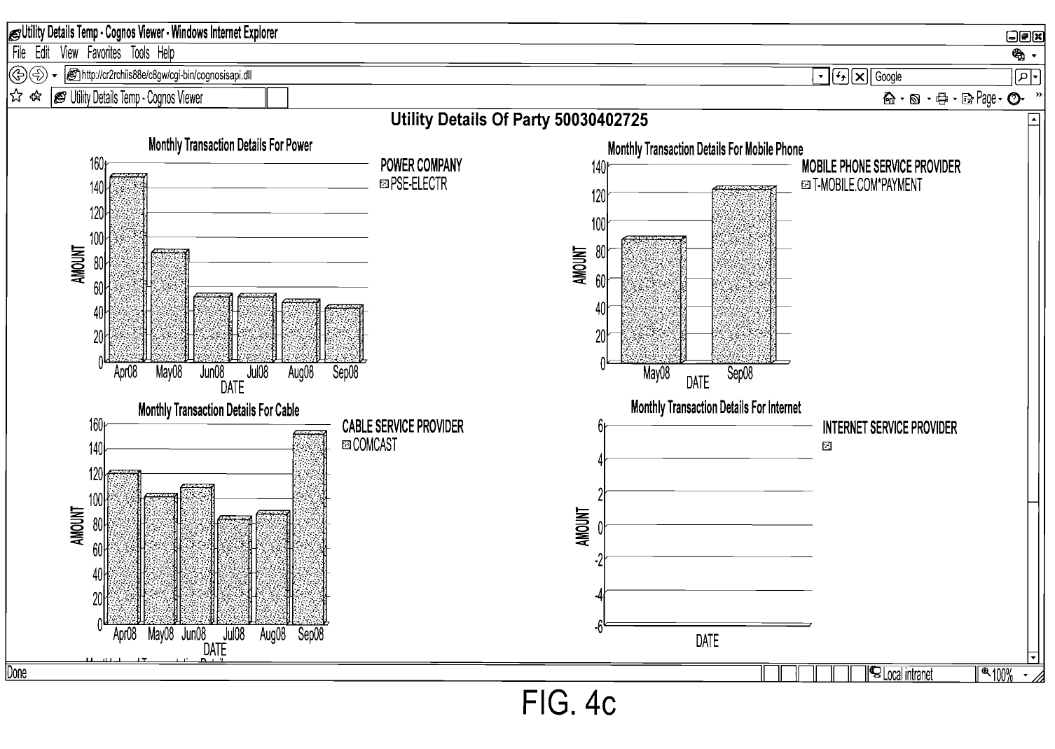

FIGS. 4a, 4b, and 4c show example screenshots of consumer transactional data metrics that the participation module of server 204 may generate to visually display consumer information. It should be noted that the participation module may generate reports of these data metrics that include representations other than in a bar graph format.

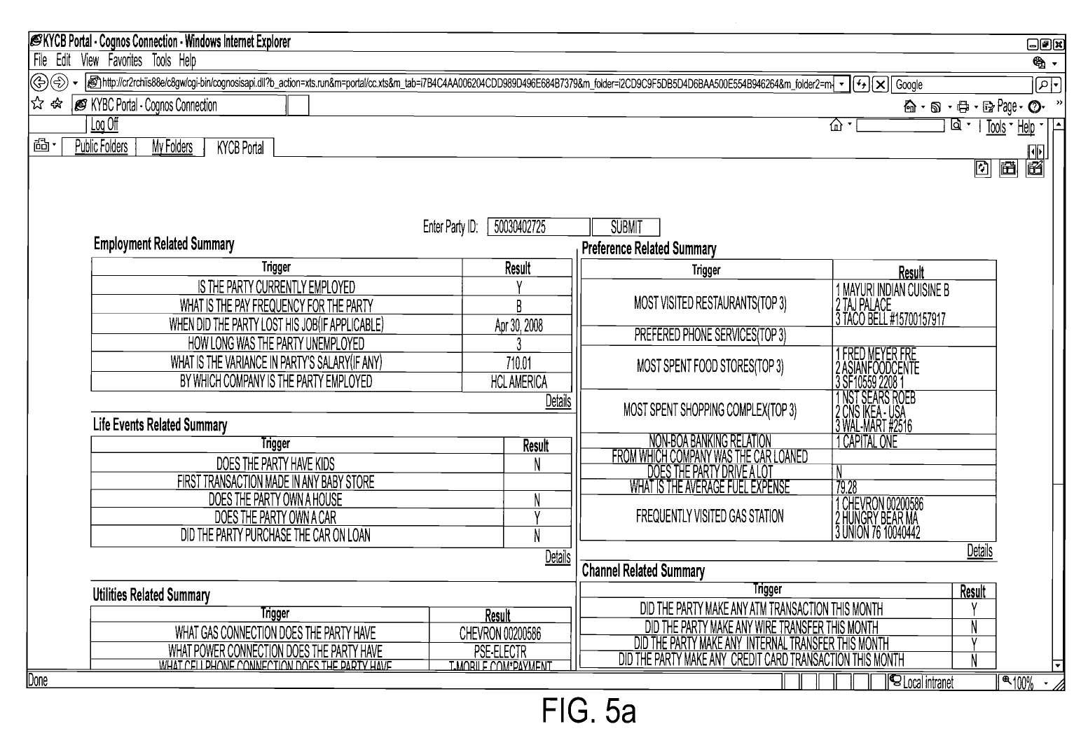

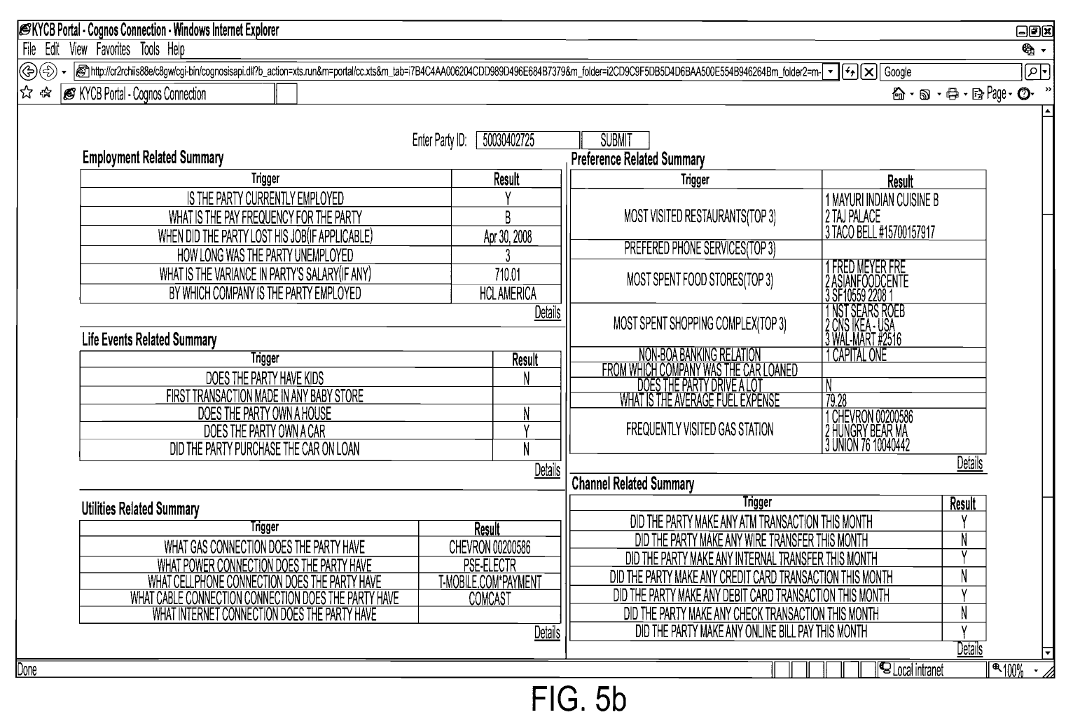

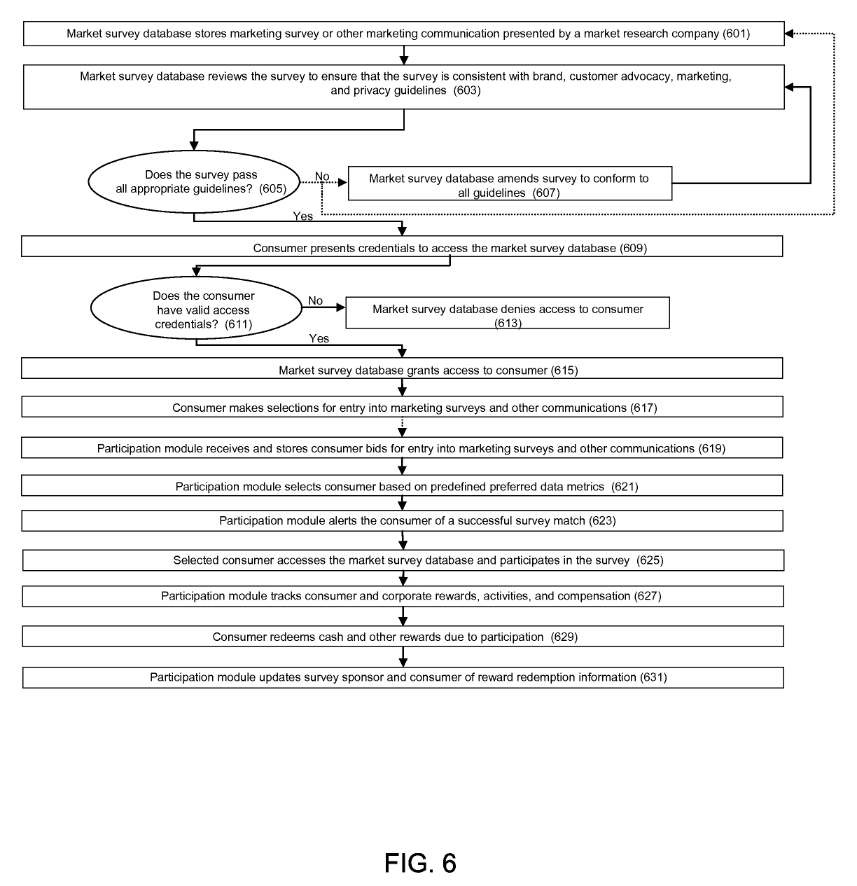

FIGS. 5a and 5b show examples of demographic and transactional data metrics associated with the profile of a particular consumer in view of a particular market survey. As shown in both FIGS. 4 and 5, the participation module of sever 204 may distill the raw transactional and demographic data into predefined preferred demographic data metrics. For example, predefined transactional and demographic data metrics shown in FIGS. 5a and 5b include “most spent food stores” and “does the party have kids?” Once the participation module has analyzed the raw data in view of a particular market survey, the module may generate reports that summarize the consumer lists and data based on the data metrics. Within the consumer list, the participation module may give accepted consumers a quantitative score to indicate how responsive they are to a particular survey. In other embodiments, the module may list accepted consumers without any other qualifier such as a score. The consumer database may screen lists to ensure that no personally identifiable consumer data is released to the survey sponsor. As described in more detail in FIG. 6, consumers may bid for entry into a particular survey. As a result, consumer lists may also include compensation algorithms that may be used in generating optimal lists of consumers for a particular survey sponsor. Reports with consumer lists may detail why the participation module may have chosen a particular compensation value in view of each consumer's transactional and demographic data and the survey sponsor's goals. Upon reviewing these algorithms, a simple example of which is shown in Table 1, the survey sponsor may adjust the preference levels and/or benefits to fit the needs of the survey. Similarly, when consumers review the list of available surveys, the rewards module may display the rewards other consumers with similar preference levels are receiving for similar surveys. After analyzing this data, the participation module may allow consumers to change their bid to be more aligned with other consumers' desired compensation levels.

The participation module may also ensure that consumer lists delivered to survey sponsors have all the necessary features to guarantee that brand, customer advocacy, marketing, and privacy guidelines are met. For instance, to ensure brand recognition, the consumer list may include a company logo or other identifier to associate the consumer list with a particular entity. Consumer advocacy, marketing, and privacy disclaimers may also be present on the generated list and detail the applicable rules and regulations and how the entity adhered to those rules. For instance, if personally identifiable information was removed through the use of a software algorithm, the data processing system may supply the analytics behind the algorithm on the list. The hardware/software used to perform these checks may be located either in the participation module of server 204 or may be located as part of a separate market list generating module within server 204.

In addition, the participation module may generate marketing contact lists for a list requester. Here, the list may include consumers already within the consumer database of server 204 who agree to be contacted by a list requester. As such, the pool of consumers that the participation module uses to generate a marketing contact list may be different from the pool of consumers that the module uses to generate a list of accepted consumers for a survey. However, the data processing system may follow all appropriate guidelines (e.g., brand recognition, consumer advocacy, etc) for this type of list as before. Consumer lists may be generated based on consumers meeting any predefined demographic and/or transaction criteria, e.g., male consumers between 35 and 39 years old, or any consumer who made a purchase at a BANANA REPUBLIC® store within the past month, etc.

Consumers may accrue rewards based on inclusion in a consumer list independent of their inclusion in a marketing survey resulting from being solicited by virtue of being on the list. For example, a consumer may receive 1 reward point (or any other reward) each time the consumer is included in a marketing list that is sent to a market researcher based on demographic and/or transactional data associated with the consumer. The consumer may separately be compensated if or when the consumer ultimately participates in a market survey. FIG. 6 is a flowchart of an illustrative method for conducting a customized marketing survey where both survey sponsors and the consumers taking part in the survey may have high degrees of control over how it is conducted in accordance with at least one aspect of the present disclosure. In step 601, survey sponsors may add surveys and other communications to a market survey database located in server 204. Examples of entities that may add a marketing survey to the system database include market research companies, surveying companies, large corporations with internal consumer research departments, academia, and news service providers that may have a desire to rapidly select a population to engage in market research to test new products, concepts, marketing campaigns, product enhancements, and/or political polling for candidates or ballot initiatives. Then, in step 603, the market survey database may review the survey to ensure that it is consistent with brand, consumer advocacy, marketing, and privacy guidelines. The process then may move to step 605 where the market survey database may make a decision as to whether the survey passes all appropriate guidelines. If it does not, then the market survey database amends the survey to meet all of the guidelines in step 607. Alternatively, the market survey database may reject the survey and terminate the survey proceedings. The option of amending the survey or terminating proceedings is shown in FIG. 6 by the presence of dashed arrows going from step 605 to step 607 or back to step 601. If the survey does meet all appropriate guidelines, then the process may move to step 609 where a consumer may present her credentials to access the market survey database. The process may then move to a decision step 611 where the market survey database may decide if the consumer has valid access credentials. A valid credential may include a simple ID and password to a network site on which the database of marketing surveys is located. If the consumer does not possess valid access credentials, then the market survey database may deny access in step 613. If the consumer has valid access credentials, then the market survey database may grant access to the consumer in step 615.

Once granted access, the consumer may then make selections for inclusion into a marketing survey or communication in step 617. Here, the consumer may have the ability to opt in separately for surveys and other types of marketing communications. Depending on the preferences of the survey sponsor, the compensation amount may be negotiable. If the compensation amount is negotiable, the participation module of server 204 may receive and store consumer bids for a certain amount of cash or other reward compensation for participating in the marketing survey in step 619. Rewards other than cash may include airline points, merchandise coupons, free gifts, among others. The marketing research company may optionally have already included a particular compensation amount for participating in the survey, as part of the survey itself. The lack of a requirement to include a consumer bidding step is shown in FIG. 6 by the method proceeding from step 617 directly to step 621.

In step 621, the participation module of server 204 may select a consumer based on predefined rules identifying maximum acceptable bids based on the comparison of the consumer's demographic information compared to one or more predefined preferred demographic data metrics. For instance, the participation module may deem a low earning consumer making a bid of $500 in exchange for participation in a marketing survey as being too expensive for allowing her to be a part of the survey, whereas a higher income consumer making such a bid would be accepted.

A consumer data metric may be any number of features associated with a person. Predefined preferred transactional data metrics may include the type of purchases made or the quantity of items purchased, among others. A consumer's age, sex, location, race, and/or education level may all be predefined preferred demographic data metrics that are used to determine whether to accept the consumer for participation in a survey. Algorithms in the participation module may statistically analyze and evaluate the raw transactional and demographic data associated with the consumer. In this way, the raw transactional and demographic data, prior to analysis, may serve as a vehicle by which the participation module of server 204 may distill and use relevant consumer data metrics for the purposes of determining the consumer's suitability for participating in a survey.

For instance, assume that the internal marketing department of an automobile manufacturer is conducting a marketing survey. This manufacturer decides to conduct a marketing survey looking to understand the automobile preferences of senior citizens. Assume that the market survey database has already stored the survey and that the consumer database has already stored a certain population of raw consumer transactional and demographic data. In conducting the survey, the car manufacturer may decide that the best candidates for its research study are those 65 years or older. However, the manufacturer may also be interested in those that are slightly younger. The level of interest in younger candidates may or may not be less than the level of interest in older candidates. If a consumer is younger, the participation module may determine that the consumer does not satisfy the predefined preferred demographic metric of age as well as those that are older.

The participation module of server 204 may analyze a particular consumer data metric on a continuous scale rather than one that outright grants or denies a consumer's ability to participate in a study. As suggested above, the participation module may also evaluate a consumer for a marketing survey based on multiple predefined preferred demographic data metrics. For instance, in the example of the marketing survey conducted to understand the automobile preferences of senior citizens, the participation module may use a second data metric such as current car ownership. The survey providers may be most interested in those senior citizens that own an automobile. As a result, the participation module may deem a person that owns an automobile more responsive to this particular marketing survey than someone that does not own one.

In addition, the participation module may assign different “weights” to multiple data metrics. For instance, in the above example, the car manufacturer may have decided that it is more important for potential consumers to be senior citizens than to currently own a car. Accordingly, the “weight,” or importance level, assigned to the metric of being a senior citizen may be more than the weight assigned to the metric of currently owning a car.

If no bidding step was made in FIG. 6, then the participation module may select a consumer for a particular marketing survey based only on his or her demographic and/or transactional data in view of predefined preferred data metrics in step 621. To make this selection, the participation module may incorporate various statistical processing and design-of-experiment modules. The algorithms used to make consumer selections may be based on a single consumer data metric or multiple data metrics given equal or unequal weights.

Going back to FIG. 6, once the participation module selects a consumer, in step 623, the participation module may alert the selected consumer of a successful match through various means, including via email, text messages (SMS), voicemail, announced on the consumer's homepage (after authentication), etc. Once the market survey database releases the survey, the selected consumer may access the market survey database and participate in the survey in step 625. Access to the survey may proceed by presenting valid access credentials as before. Once the consumer finishes the survey, the participation module then may track consumer and corporate rewards, activities, and compensation in step 627. For instance, the participation module may keep track of records showing that a consumer has completed the required marketing survey. If so, the participation module may authorize a gift check to be released, for example, five days after completion. If corporate affiliates are involved, the participation module may allow any earned rewards to be directly credited to a consumer's account with the affiliate. If a particular consumer has more than one corporate affiliate account, the consumer may have the ability to designate which corporate affiliate account is credited with a reward payment. In addition, corporate affiliates may also have the option of participating in the direct deposit of earned rewards. In this embodiment, corporate affiliates may provide consumer data but may not allow for receipt of reward credits to consumer accounts associated with their business. Then in step 629, the consumer may redeem his or her rewards. Finally, in step 631, the participation module may update the corporate and individual consumers of award redemptions.

As an example consider the case of a marketing research company desiring to evaluate the popularity of a new running shoe among females. The marketing company may decide to add a survey to the market survey database to describe the new shoe features and receive feedback from women that might be interested in these shoe features. After adding the survey, consumers who have decided to receive offers for surveys and marketing communications may be able to review the survey and decide to bid on the compensation amount in return for participation. Alternately, the marketing research company may restrict the type of people who may review the survey immediately after adding the survey to the system. In this case, the marketing research company decides not to enter any such restrictions in the beginning.

Assume that at least three of the consumers within the consumer database review the survey and decide that they would like to participate in the opportunity. The first is a twenty-six year old female, the second is a fifty-seven year old male, and the third is a thirty-five year old female. Assume also that the participation module stores that the first candidate bids to receive $200 in cash compensation for participating in the survey, the second candidate desires to receive bonus airline miles, and the third candidate desires to receive coupons for a movie.

After entering their bid amounts for the rewards, the participation module may determine who to select for survey participation based on consumer data metrics. It should be noted that if the marketing research company had placed restrictions on who could participate in the survey, the system may have automatically run algorithms to throw out some consumers and keep others based on their data metrics. If restrictions on participants were immediately set, the participation module may have immediately tossed out the second consumer, a fifty-seven year old male, because he is male and the new product opportunity is for a new type of women's shoe. The participation module may have also thrown out the first consumer if the survey sponsor deems that the $200 reward that she requests is too expensive for the company's budget. But in this case, the marketing research company has set no restrictions initially, so the participation module may set these filters after reviewing the consumer information. In this case, assume that the participation module does eventually use these predefined preferred data metrics (i.e., females only and bid amount), and hence the module may accept only the third consumer for the survey based on the fact that she is a female and has made what is seen to be a reasonable reward request.

The participation module may then create a final list of accepted consumers to notify them that they have been accepted to participate in the marketing survey. The acceptance on the part of the marketing research company may or may not bind the consumers to participate. Assume that in this case the acceptance is nonbinding, but instead provides the consumer some predefined amount of time in which to complete the survey (e.g., n days) and receive her award. The third consumer mentioned above, among others, decides to participate in the marketing survey detailing whether or not she would be excited about the new features in the women's shoe line about to be released. Once she has received and completed the survey in the market survey database, the participation module may notify the marketing research company that this consumer has completed the task, and for her time, the participation module may distribute free movie coupons to her, as she had requested (or other reward). It should be noted that other consumers may have bid different cash amounts or other rewards to be delivered in different ways.

Once the thirty-five year old female from above receives her movie coupons, the participation module updates both the marketing research company and the consumer that receipt has been made. When this consumer uses her movie coupons at the theater the following weekend, the participation module again updates the consumer and the marketing research company that the reward has been redeemed. In this way, the system is able to track in real-time progress of the survey from initial creation to award redemption and beyond.

This platform may serve to eliminate the bias from studying inadequate sample sizes of marketing surveys because the available population using transactional and associated demographic data may be quite large. Additionally, validation and security procedures may be built-in to the system and may serve to give the platform additional credibility. Because in certain traditional marketing survey situations, some individuals may provide inaccurate or misleading information in order to prequalify for specific studies and research, certain embodiments of the current system may inherently corroborate consumer-supplied information including demographics and financial status because the transactional and demographic data underpinning the consumer data metrics may have already been verified.

Moreover, by targeting consumers that have already bid on certain marketing opportunities or have just opted into the system, certain embodiments of the present disclosure may allow the consumers to be in control of how often one is willing to receive communications, how much one is willing to accept in the form of compensation, and to what messages one would be willing to evaluate.

While illustrative systems and methods as described herein embodying various aspects of the present disclosure are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present invention.

What is claimed is:

1. A data processing system, comprising
a consumer database storing transactional data and demographic data for a plurality of consumers, wherein each transaction data entry corresponds to a purchase by one of the consumers, wherein the demographic data comprises non-personally identifiable information, and wherein said consumer database prevents exposure to personally identifiable information by a market researcher;
a market survey database storing market survey data received from the market researcher, and storing market survey responses from a plurality of consumers selected to participate in the market survey, wherein each consumer is selected based on his or her corresponding demographic data as compared to one or more predefined preferred demographic data metrics identified by the market researcher;
a participation module for receiving bids from consumers to participate in the market survey, wherein each bid represents a reward the corresponding consumer desires to receive in exchange for participation in the survey, and for determining whether to accept the consumer for participation in the survey based on predefined rules identifying maximum acceptable bids based on the comparison of the consumer's demographic information compared to the one or more predefined preferred demographic data metrics; and
a marketing list generation module for generating a consumer list based on predefined criteria specified by a market researcher, wherein said consumer list includes contact information for a plurality of consumers meeting the predefined criteria specified by the market researcher, wherein said plurality of consumers have each opted-in for inclusion in said consumer list.

2. A system, comprising:
a consumer database storing transactional data and demographic data for a plurality of consumers, wherein each transaction data entry corresponds to a purchase by one of the consumers, wherein the demographic data comprises non-personally identifiable information, and wherein said consumer database prevents exposure to personally identifiable information by a market researcher; and
a market survey database storing market survey data received from the market researcher, and storing market survey responses from a plurality of consumers selected to participate in the market survey, wherein each consumer is selected based on his or her corresponding demographic data as compared to one or more predefined preferred demographic data metrics identified by the market researcher.

3. The system of claim 2, further comprising:
a participation module for receiving bids from consumers to participate in the market survey, wherein each bid represents a reward the corresponding consumer desires to receive in exchange for participation in the survey, and for determining whether to accept the consumer for participation in the survey based on predefined rules identifying maximum acceptable bids based on the comparison of the consumer's demographic information compared to the one or more predefined preferred demographic data metrics.

4. The system of claim 2, further comprising a user interface in the consumer database through which each consumer can update his or her corresponding demographic data.

5. The system of claim 2, wherein the market survey database reviews the market survey to ensure that the market survey is consistent with brand, consumer advocacy, marketing, and privacy guidelines.

6. The system of claim 3, wherein the participation module sends a notification to the consumer upon an occurrence of a predefined event associated with a status of the market survey.

7. The system of claim 3, wherein the participation module generates a report that lists the accepted consumers based on the selection of the consumers using the corresponding demographic data as compared to the one or more predefined preferred demographic data metrics identified by the market researcher

8. The system of claim 2, wherein the one or more predefined preferred demographic data metrics include at least one age, financial data, race, geographic location, and gender.

9. The system of claim 2, wherein the one or more predefined preferred demographic data metrics comprises the consumer being associated with a predefined transaction.

10. The system of claim 3, wherein the participation module credits the reward to a consumer's bank account when the consumer has completed the market survey.

11. The system of claim 3, further comprising a user interface through which corporate affiliates can add more transactional and demographic data about the consumer.

12. The system of claim 11, wherein the participation module directly credits the reward to the consumer's account at the corporate affiliate.

13. A method comprising:
receiving transaction data and demographic data for a plurality of consumers;
storing the transaction data and demographic data for the plurality of consumers in a consumer database, wherein each transaction data entry corresponds to a purchase by one of the consumers and wherein the demographic data comprises non-personally identifiable information;
preventing exposure to personally identifiable information by a market researcher;
storing market survey data received from the market researcher in a market survey database;
selecting a plurality of consumers based on each consumer's corresponding demographic data as compared to one or more predefined preferred demographic data metrics identified by the market researcher;
receiving market survey responses from the plurality of consumers; and
storing the market survey responses from the plurality of consumers selected to participate in the market survey in the market survey database.

14. The method of claim 13, further comprising:
receiving bids from the plurality of consumers to participate in the market survey, wherein each bid represents a reward the corresponding consumer desires to receive in exchange for participation in the survey; and
determining whether to accept the consumer for participation in the survey based on predefined rules identifying maximum acceptable bids based on the comparison of the consumer's demographic information compared to the one or more predefined preferred demographic data metrics.

15. The method of claim 13, further comprising receiving updated demographic data from the consumer and updating the database with the updated demographic data.

16. The method of claim 14, further comprising generation of graphs and reports to visualize results of the survey.

17. The method of claim 14, further comprising sending a notification to the market researcher upon an occurrence of a predefined event associated with a status of the market survey.

18. The method of claim 14, further comprising generating a report that lists the accepted consumers based on the selection of the consumer using the corresponding demographic data as compared to the one or more predefined preferred demographic data metrics identified by the market researcher.

19. The method of claim 13, wherein the one or more predefined preferred demographic data metrics include at least one age, financial data, race, geographic location, and gender.

20. The method of claim 13, wherein the one or more predefined preferred demographic data metrics comprises the consumer being associated with a predefined transaction.

21. The method of claim 14, further comprising crediting the reward to a consumer's bank account when the consumer has completed the market survey.

22. The method of claim 13, further comprising reviewing the market survey to ensure that it is consistent with brand, consumer advocacy, marketing, and privacy guidelines.
